(19) United States
(12) Patent Application Publication
(10) Pub. No.: US 2026/0187558 A1
(43) Pub. Date: Jul. 2, 2026

(54) Replica Remote Job Execution Engines

(71) Applicant: PagerDuty, Inc., San Francisco, CA (US)

(72) Inventors: Jake William Cohen, Santa Barbara, CA (US); Gregory West Schueler, Portland, OR (US); Luis Esteban Toledo, Santiago (CL); Krithivasan Nagarajan, San Jose, CA (US)

(21) Appl. No.: 19/005,202

(22) Filed: Dec. 30, 2024

(51) Int. Cl. G06Q 10/0631

(52) U.S. Cl. CPC G06Q 10/06316; G06F 9/466

(57) ABSTRACT

An automation task execution request is received from a service runner instance. A determination is made that an automation task is scheduled for execution at a target node by one of two or more service runner instances. The two or more service runner instances include the service runner instance. The automation task is assigned to the service runner instance based on the determination that the automation task is scheduled for execution at the target node by the one of two or more service runner instances.

### TECHNICAL FIELD

This disclosure relates generally to computer operations and more particularly, but not exclusively, to remotely executing automation tasks using a shared service runner.

### SUMMARY

A first aspect of the disclosed implementations is a method that includes receiving an automation task execution request from a service runner instance; determining that an automation task is scheduled for execution at a target node by one of two or more service runner instances, wherein the two or more service runner instances include the service runner instance; and assigning the automation task to the service runner instance based on determining that the automation task is scheduled for execution at the target node by the one of two or more service runner instances.

A second aspect of the disclosed implementations is a method that includes associating service runner instances with a service runner definition, wherein the service runner definition identifies target nodes, wherein each service runner instance of the service runner instances is configured to execute automation tasks on the target nodes; receiving a request to execute an automation task on a target node; determining that the target node is one of the target nodes; and assigning, in response to determining that the target node is one of the target nodes, the automation task to a service runner instance of the service runner instances.

A third aspect of the disclosed implementations is a system that includes a memory subsystem configured to store instructions; and processing circuitry configured to execute instructions to associate service runner instances with a service runner definition, wherein the service runner definition identifies target nodes, wherein each service runner instance of the service runner instances is configured to execute automation tasks on the target nodes; receive a request to execute an automation task on a target node; determine that the target node is one of the target nodes; and assign, in response to determining that the target node is one of the target nodes, the automation task to a service runner instance of the service runner instances.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for dynamic, distributed automation task management across multiple target nodes using replica remote job execution engines.

FIG. 5 is a block diagram of a system for managing and executing automation tasks across multiple target nodes within an infrastructure.

FIG. 6 is a block diagram of a system for managing service runner instances across multiple utility nodes within an infrastructure.

FIG. 7 is a flowchart of a technique for assigning automation tasks to a service runner instance within an infrastructure.

FIG. 8 is a flowchart of a technique for assigning parallel and sequentially executed automation tasks to a service runner instance within an infrastructure.

FIG. 9 is a flowchart of a technique for receiving an automation task execution request from a service runner instance.

FIG. 10 is a flowchart of a technique for updating a health status of a service runner instance.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology service of an organization. An event can be or describe a fact at a moment in time that may consist of a single or a group of correlated conditions that have been monitored and classified into an actionable state. As such, a monitoring tool of an organization may detect a condition in the IT environment (e.g., such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may not be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

When responding to an incident, a user (i.e., a responder) may document the steps taken during the response that led to a resolution. Additionally, the user may want to automate those steps so that future responses to the same or similar incident types can be handled via automation (e.g., a job). The steps may be grouped together and executed in a predefined order as a job. A job may be defined by a job definition. A job definition may detail each command to be executed and the order in which to execute the commands. As such, a job definition includes an ordered set of steps (i.e., automation tasks).

As a more general proposition, there is a need to execute jobs on designated target nodes to effectively manage and maintain a managed environment. Organizations often require specific automation tasks to be performed directly on target nodes. For example, a cloud service provider may need to deploy software updates to multiple servers within a data center, requiring each update job to execute on targeted servers. Another example includes performing diagnostic checks on critical systems within a managed IT environment, where each diagnostic job is executed on specific security nodes to promptly address potential vulnerabilities. A target node, as used herein refers to a host, a server, an endpoint, or the like that exists in an IT infrastructure (e.g., datacenter, a cloud environment, an IT infrastructure, and the like) controlled by one organization that is separate from, and not directly accessible to, an EMB, which is deployed in another IT infrastructure (e.g., a cloud-based system) that is controlled by another organization (e.g., a service provider).

An automation task associated with a job definition may specify a target node where at least a portion (e.g., some steps) of the automation task is to be executed (e.g., performed), such as by a processor or processors of the target node. To execute an automation task according to a job definition, the EMB may connect to multiple target nodes using various protocols (e.g., secure shell host (SSH), Windows Remote Management protocol (WinRM), application programming interface (API), script, etc.) to execute commands described in the job definition. In certain configurations, the EMB may not be communicatively connected to a target node. Thus, a utility node that is communicatively connected to both of the EMB and the target node may obtain a job definition from the EMB and cause automation tasks to be performed at the target node according to the job definition.

As such, connecting to a target node to execute at least some steps of an automation task may use a remote dispatch mechanism that uses a software program (referred to herein as a “runner program”). The runner program may be installed on a host (e.g., utility node, utility device) that is communicatively connected to the target node. The runner program may be located within the same infrastructure as the target node. The runner program may then execute commands on the target node using one or more remote communication protocols (e.g., SSH, WinRM, etc.). The runner program may also be configured to execute commands on the utility node itself. Said another way, the runner program may be configured to execute commands (e.g., tasks) locally. That is, the utility node can also be a target node. The target nodes that the runner program is capable of executing commands on is defined by a runner definition. A runner definition is a configuration that identifies a group of target nodes on which the runner program is configured to execute tasks. Each runner program is associated with one runner definition and a runner definition is associated with one runner program.

Conventional techniques for managing automated tasks in managed environments face limitations related to scalability and task distribution. Conventional systems are prone to single points of failure, disrupting jobs if a remote dispatch mechanism becomes unavailable. These systems also lack efficient scaling mechanisms to handle increasing workloads, leading to performance bottlenecks. Furthermore, conventional systems lack a sophisticated approach to automation task distribution, resulting in uneven workloads and inefficient resource utilization. Therefore, a system is needed that provides scalability and efficient automation task distribution for managing automation tasks in managed environments.

Implementations according to this disclosure solve problems such as those described above by introducing a system for dynamic, distributed automation task management across multiple target nodes using replica remote job execution engines (i.e., service runner instances). The system enhances redundancy by allowing multiple service runner instances to be associated with a service runner definition. If one service runner instance fails (e.g., becomes unresponsive), the automation tasks can be assigned to another service runner instance. The EMB uses service runner definitions as a configuration layer to manage distributed task execution. A service runner definition at the EMB serves as a centralized configuration that identifies a specific group of target nodes and can be associated with multiple service runner instances. The service runner definition specifies which target nodes its associated service runner instances are configured or enabled to execute tasks on.

Service runner instances associated with a service runner definition are replica software programs deployed on utility nodes within a target infrastructure. These instances can execute tasks on any target node specified by their associated definition. Each service runner instance retrieves automation tasks from a task queue managed by the EMB and is capable of executing commands both remotely on target nodes and locally on its host utility node. In some implementations, automation tasks may be pushed to service runner instances using a long-live transmission control protocol (TCP) connection (e.g., WebSocket connection). In some implementations, some service runner instances may be persistent, and others may be ephemeral, instantiated dynamically to address temporary workload demands or to respond to changes in system conditions, such as resource constraints or task surges.

As further described, this definition-based architecture enhances redundancy by enabling multiple service runner instances to be associated with a single definition, ensuring continuity in task execution even if individual instances fail. Additionally, the approach supports intelligent task distribution by dynamically considering factors such as service runner health status, parallel versus sequential execution requirements, workload thresholds, and target node-to-runner ratios. The inclusion of ephemeral service runner instances further allows for optimized resource utilization and system flexibility in dynamic infrastructure environments.

Scalability is improved through dynamic allocation of service runner instances based on real-time conditions, such as health status or workload demands. This allows the system to adapt to varying workloads and prevent performance bottlenecks. The system also provides a mechanism for efficient task distribution across the service runner instances. The system can assign tasks based on various factors, such as the target node, sequential or parallel execution requirements, load balancing needs, and the ratio of target nodes to available service runner instances.

There are numerous examples of remote job execution of automation tasks via replica remote job execution engines outside the context of event and/or incident management. An automation job that is executable by a service runner instance as described herein may generally be used to automate many different aspects of business and/or technical operations where it is desirable to carry out the automation task in an infrastructure that may or may not be accessible from another infrastructure (such as one where an EMB may be executing or deployed).

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, information technology services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, who may be responsible for responding to an event associated with a monitored application or service. A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using Short Message Service (SMS) texts, MMS texts, email, Instant Messages, mobile device push notifications, hypertext transfer protocol (HTTP) requests, voice calls (telephone calls, Voice Over Internet Protocol (VOIP) calls, or the like), library function calls, API calls, universal resource locators (URLs), audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

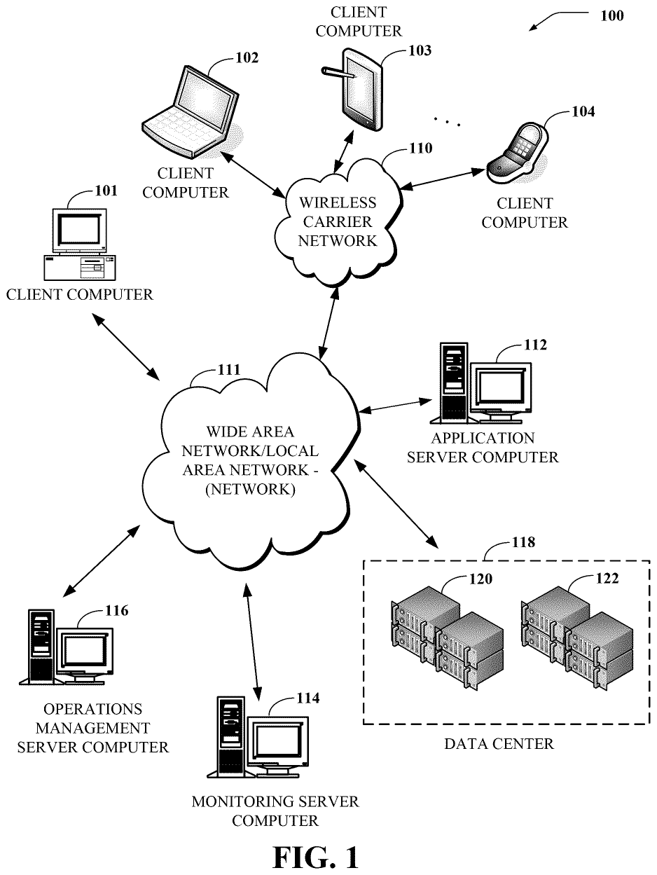

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including wireless application protocol (WAP) messages, or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

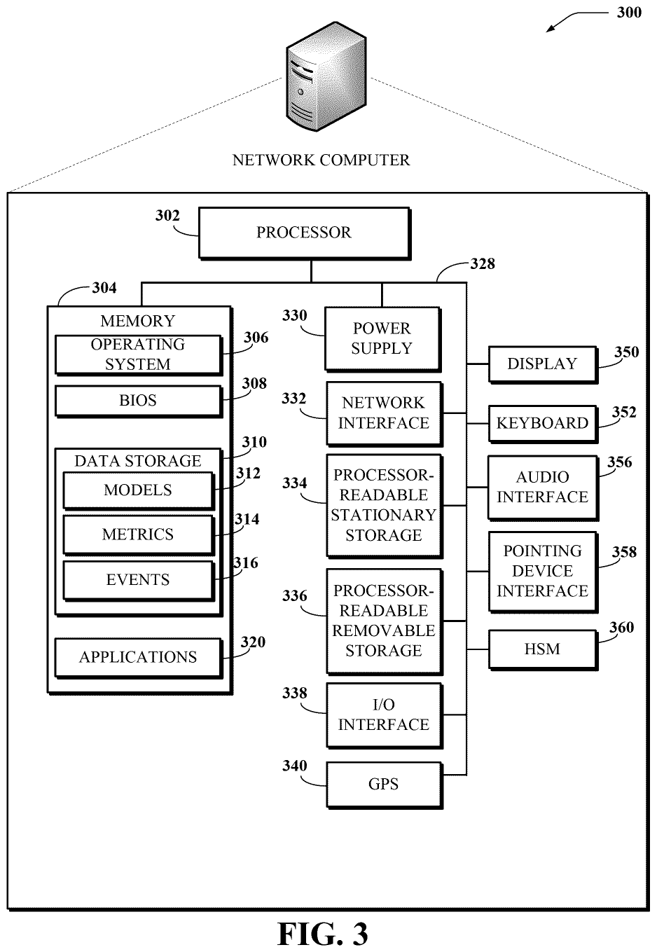

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

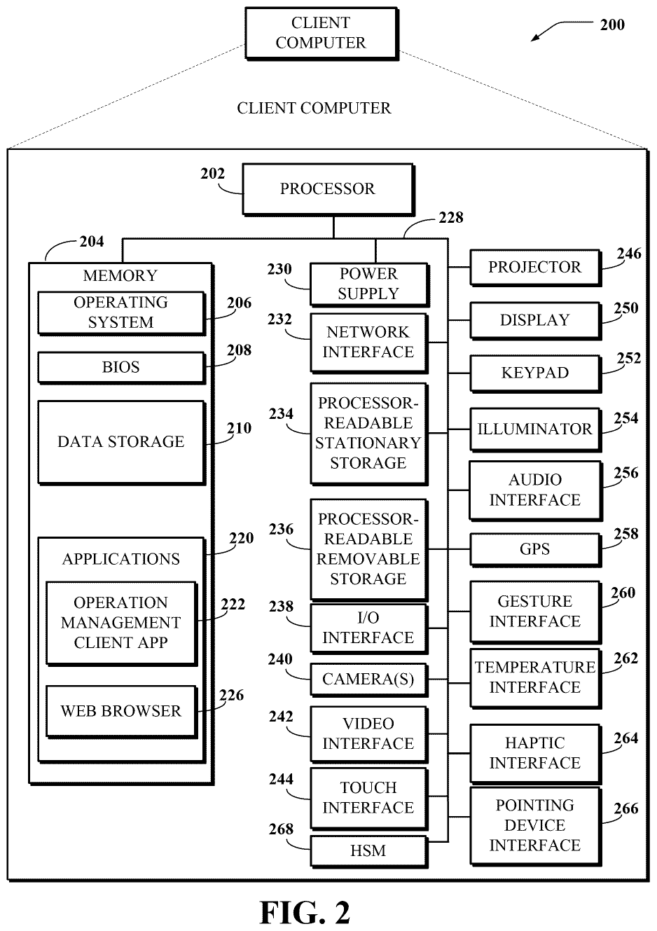

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output (I/O) interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the Open Systems Interconnection (OSI) model for mobile communication, GSM, code division multiple access (CDMA), time division multiple access (TDMA), user datagram protocol (UDP), transmission control protocol/Internet protocol (TCP/IP), SMS, MMS, GPRS, WAP, ultra-wide band (UWB), WiMax, Session Initiation Protocol/Real-time Transport Protocol (SIP/RTP), GPRS, EDGE, WCDMA, long term evolution (LTE), universal mobile telecommunications system (UMTS), orthogonal frequency division multiplexing (OFDM), CDMA2000, evolution-data optimized (EV-DO), high-speed downlink packet access (HSDPA), or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS receiver 258 can determine the physical coordinates of the client computer 200 on the surface of the earth, which typically outputs a location as latitude and longitude values. The GPS receiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS receiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth Low Energy (LE), Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including WAP messages, and the like. In at least one embodiment, the browser application is enabled to employ HDML, WML, WMLScript, JavaScript, SGML, HTML, XML, HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a Basic Input/Output System (BIOS) 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or iOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, VOIP applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, Multimedia Messaging Service (MMS), general packet radio service (GPRS), WAP, UWB, Institute of Electrical and Electronics Engineers (IEEE) 802.16 Worldwide Interoperability for Microwave Access (WiMax), SIP/RTP, or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a LCD, gas plasma, electronic ink, LED, OLED or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), E-OTD, Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows ® operating system, or Apple Inc.'s iOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, VOIP applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for defining workspaces, associating automation tasks (e.g., job definitions therefor) with the workspaces, enabling configuration of service runner definitions therewith, and configuring service runner instances to execute automation tasks. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, that include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces as well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 110 or the network 111.

Also, in at least one of the various embodiments, at least some of the applications 320, may be located in virtual servers running in a cloud-based computing environment rather than being tied to one or more specific physical network computers.

Further, the network computer 300 may also comprise a HSM 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as SOC, or the like.

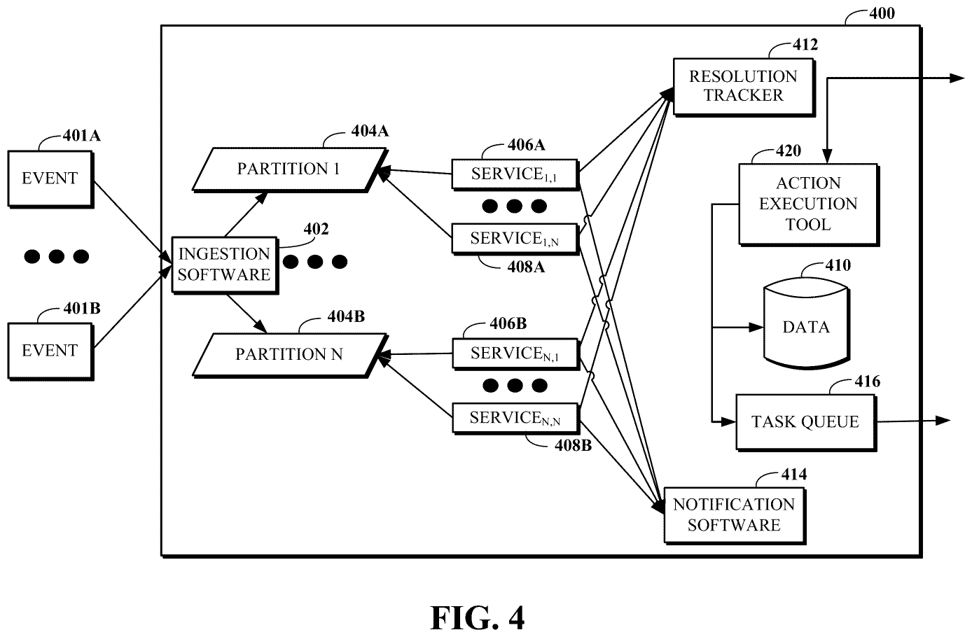

FIG. 4 illustrates a logical architecture of a system 400 for dynamic, distributed automation task management across multiple target nodes using replica remote job execution engines.

In at least one of the various embodiments, a system for remote job execution for incident response may include various components. In this example, the system 400 includes an ingestion software 402, one or more partitions 404A-404B, one or more services 406A-406B and 408A-408B, a data store 410, a resolution tracker 412, a notification software 414, a task queue 416, and an action execution tool 420.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store jobs and job definitions. The template data can be used to identify (e.g., select, choose, infer, determine, etc.) a template for a job or a job definition.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, a task queue 416 may be arranged to maintain a list of automation tasks to be executed within an infrastructure. The task queue 416 may receive an automation task from the action execution tool 420. The automation task may be added to the task queue 416 via an API. The task queue 416 may be queried for a list of automation tasks to be executed within an infrastructure via an API. The task queue may be queried for a list of automation tasks to be executed by a service runner instance via an API. The task queue 416 may have an automation task removed from the task queue 416 via an API, using a graphical user interface, or the like.

While the task queue 416 is named to include the term “queue” implying that it may be a data structure with certain semantics, no such limitations are intended. The task queue 416 can be implemented as a software program or executable instructions that stores data as a database, a linked list, a priority queue, an array, or any other suitable data structure capable of storing and managing automation tasks (or definitions therefor). The task queue 416 may be configured to prioritize certain automation tasks over others based on predefined criteria.

Additionally, the task queue 416 may support various operations such as automation task addition, deletion, updating, and querying. These operations can be performed via an API, which allows for programmatic interaction with the task queue 416. The API provides a set of defined endpoints and protocols for performing operations on the task queue 416, thereby facilitating automation and integration with other components of the system 400 and service runners, as further described herein.

The action execution tool 420 may receive actions selected by a responder. The action execution tool 420 may include facilities (e.g., tools, software, utilities, or the like) for transmitting the actions to, or causing the actions to be carried out by, IT components in the managed environments. For at least some of the actions, the IT components in the managed environments may return data (e.g., feedback data) to the action execution tool 420 indicating whether the actions were successful or other status data. That data is returned to the action execution tool 420 includes that the data are received by the resolution tracker 412, which stores the data in the data store 410, and those data used (e.g., retrieved) by the action execution tool 420 from the data store 410. The action execution tool 420 may store such status data in the data store 410. For example, the action execution tool 420 may store status data in association with corresponding actions and the alerts for which the actions were performed.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain diagnostic information from an infrastructure regarding incidents assigned to or acknowledged by the responder. A user interface can be used to obtain information about known remediations being performed on the infrastructure and associated with an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

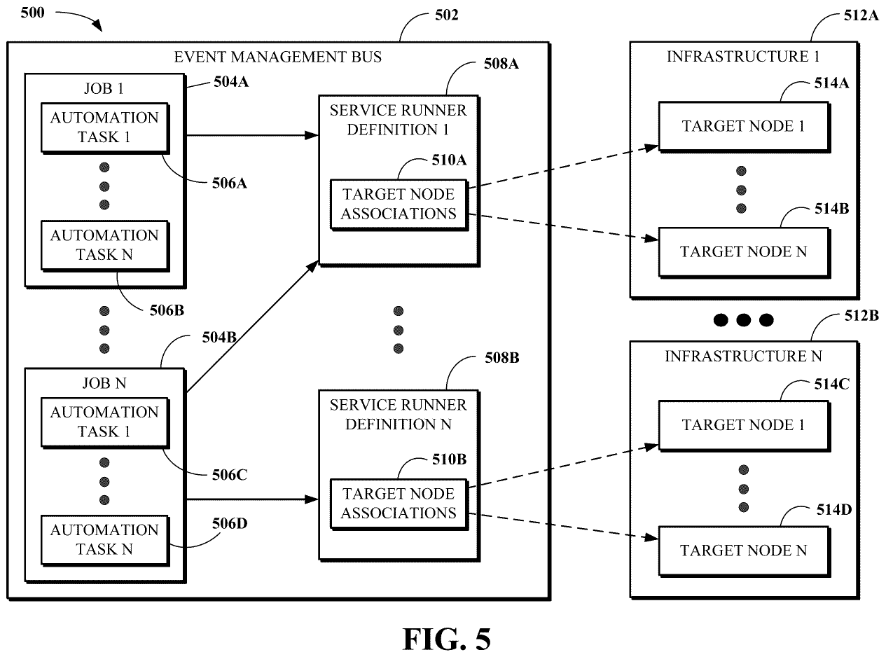

FIG. 5 is a block diagram of a system 500 for managing and executing automation tasks across multiple target nodes within an infrastructure. The system 500 may include an EMB 502, one or more jobs 504A-504B (defined or created via the EMB 502), one or more automation tasks 506A-506D, one or more service runner definitions 508A-508B, one or more task node associations 510A-510B, one or more infrastructures 512A-512B, and one or more target nodes 514A-514D. The EMB 502 may be the system 400 of FIG. 4.

An infrastructure, such as each of the infrastructures 512A-512B, may be or serve as a defined operational environment. An infrastructure can vary in form and may represent a data center, a cloud environment, a virtualized network, a hybrid configuration that blends on-premises and cloud resources, a group of devices, a group of devices having different IP ranges, or the like. As such, an infrastructure can be understood, as a common denominator, to represent a collection of devices (e.g., target nodes).

The EMB 502 is configured to define and manage one or more jobs, such as jobs 504A-504B, which represent sequences of automation tasks tailored for specific operational needs. Each job may be structured to accomplish a particular objective, such as system diagnostics, software deployment, or security monitoring. Within a job, individual automation tasks, such as automation tasks 506A-506D, are defined. Each automation task can be defined independent of other automation tasks defined within the job allowing each automation task to be separately assigned and executed. For example, each automation task may be configured to execute different commands on a different target node. As such, each automation task may be assigned and executed by a different service runner instance as described in more detail below. Additionally, automation tasks may be configured for either parallel or sequential execution. When configured for parallel execution, multiple automation tasks may be distributed across different service runner instances and executed simultaneously. When configured for sequential execution, multiple automation tasks may be assigned to the same service runner instance to ensure they are executed in a specific order.

Each job in the system 500 is associated with one or more service runner definitions, such as service runner definitions 508A-508B. The association between a job and a service runner definition is determined by the target nodes that the service runner definition identifies, and the target node designated by each automation task defined within the job. The assignment of target nodes to each service runner definition is managed through target node associations, such as target node associations 510A-510B. Each target node association specifies which target nodes a service runner instance, associated with the service runner definition, can execute tasks on, allowing the system 500 to route automation tasks defined within jobs to the service runner instance configured to execute commands on the specified target nodes.

Within each of the infrastructures 512A, 512B, there may be multiple target nodes, such as target nodes 514A-514D. The target nodes 514A-514D may include, but are not limited to, servers, virtual machines, endpoint devices, or other computing resources on which automation tasks are executed. An automation task may be directed to a single target node or to multiple target nodes. Each target node association specifies which service runner definitions are connected to which target nodes within an infrastructure. By defining these associations, the system 500 enables targeted automation task execution, whereby an automation task is matched to a service runner definition associated with service runner instances capable of executing the automation task on the designated target node.

When a job is initiated (e.g., created), the EMB 502 analyzes each automation task therein to determine a target node (or target nodes) on which the automation task is to be executed. The EMB 502 then utilizes the target node associations to identify the service runner definition(s) associated with the target node(s). As such, the EMB 502 assigns automation tasks to service runner instances associated with the service runner definition, based on the intended execution environment (e.g., the target nodes). This approach provides efficiency and accuracy in automation task assignment, as each automation task is assigned to the service runner instance based on a target node.

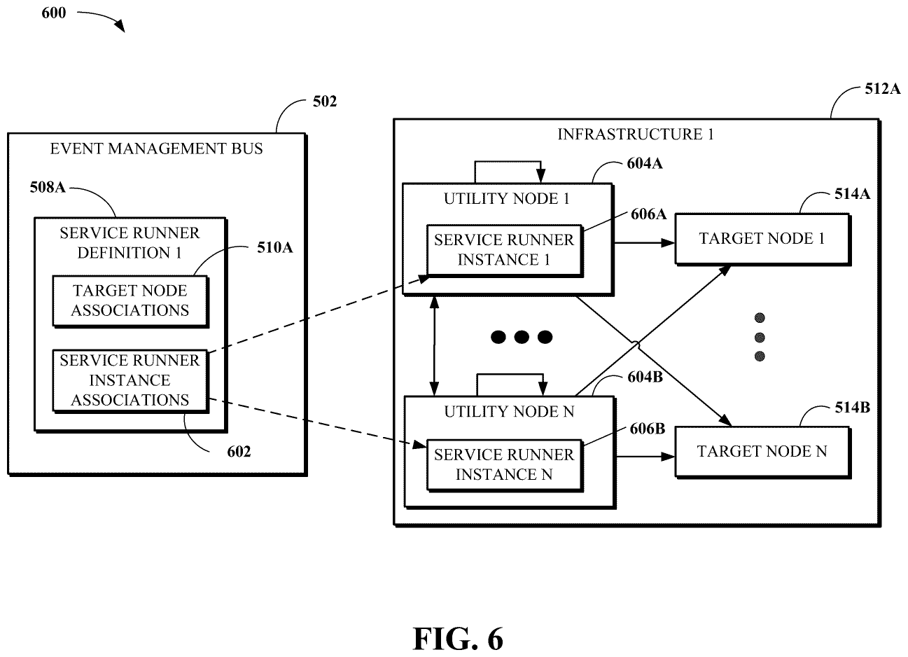

FIG. 6 is a block diagram of a system 600 for managing service runner instances across multiple utility nodes within an infrastructure. FIG. 6 further elaborates on or expands on the description of the system 500 of FIG. 5. As shown in FIG. 6, the system 600 includes the EMB 502 of FIG. 5, the service runner definition 508A of FIG. 5, the task node associations 510A of FIG. 5, service runner instance associations 602, the infrastructure 512A of FIG. 5, one or more utility nodes 604A-604B, one or more service runner instances 606A-606B, and one or more target nodes 514A-514B.

The service runner definition 508A, in addition to the components described in reference to FIG. 5 above, also includes service runner instance associations 602. The service runner instance associations 602 link (e.g., associate) the service runner definition 508A to service runner instances, such as the service runner instances 606A-606B, that have been deployed to utility nodes, such as utility nodes 604A-604B, within the infrastructure 512A. Using the service runner instance associations 602, the system 600 can connect the parameters of the service runner definition 508A, such as automation task execution capabilities, security configurations, and communication protocols, with the actual service runner instances 606A-606B deployed on the utility nodes 604A-604B.

By linking the service runner definition 508A to deployed service runner instances, via the service runner instance associations 602, the system 600 enables flexibility and scalability. Each service runner instance is identified by a unique identifier (ID) and operates as an independent agent within the infrastructure 512A, capable of executing automation tasks on one or more target nodes. Since each service runner instance operates as an independent agent, the system 600 can distribute automation tasks across multiple utility nodes 604A-604B based on workload demand or changes in the infrastructure 512A conditions. For example, in a scenario where the infrastructure 512A experiences a surge in automation tasks during peak operational hours, the system 600 can adjust the assignment of automation tasks to service runner instances to distribute the automation tasks accordingly. As another example, to timely complete an automation task that is to be run on many target nodes, the automation task may be assigned to multiple server runner instances, each completing the automation task on a subset of the many target nodes. As an automation task is assigned by the EMB 502, the system 600 analyzes a health status of each service runner instances configured to execute the automation task and distributes the automation tasks across the service runner instances to allow for optimal automation task execution.

The health status of a service runner instance provides a real-time assessment of the operational state and ability to execute automation tasks of the service runner instance. The health status is a dynamic measure that reflects the current condition of the service runner instance, taking into account factors such as the responsiveness of the service runner instance, the available resources of the service runner instance, and any potential errors or issues the service runner instance may be encountering. The system 600 can evenly distribute automation tasks or adjust assignments based on the number of available service runner instances relative to the total number of target nodes required by the automation tasks as further described herein.

If the number of automation tasks exceeds a predefined threshold, the EMB 502 can automatically distribute the automation tasks across service runner instances to prevent overload on any single service runner instance. Additionally, by allocating automation tasks in real-time, according to the available infrastructure capacity, the EMB 502 avoids potential latency spikes in automation task execution and maximizes throughput of automation tasks.

Additionally, each service runner instance operates independently from the other service runner instances, acting as a dedicated agent that retrieves automation tasks from the EMB 502. By deploying multiple service runner instances, such as service runner instances 604A-604B, within the infrastructure 512A, the system 600 can distribute automation tasks efficiently and enhances parallel execution of automation tasks.

The service runner instances 606A-606B are installed on utility nodes 604A-604B, respectively, within the infrastructure 512A. The utility nodes 604A-604B are configured to be in communication with the target nodes 514A-514B, such that the utility nodes 604A-604B can execute commands on the target nodes 514A-514B via service runner instances installed therein. Additionally, and already mentioned, at least some of the utility nodes 604A-604B may themselves be target nodes.

The service runner instances 606A-606B communicate with the EMB 502 to retrieve automation tasks, report status updates, and log results, ensuring continuous automation task management and oversight within the infrastructure 512A. Automation tasks may be retrieved from the EMB 502 via the task queue 416 using an API. The API defines a set of endpoints and protocols that the service runner instances 606A-606B can use to interact with a task queue of the EMB 502, which can be the task queue 416 of FIG. 4. These endpoints may include functionalities such as, but not limited to querying for available automation tasks, or updating a status of an automation task. For example, a service runner instance can periodically query the task queue for automation tasks that the EMB 502 determines can be executed by that service runner instance, such as based on the task definition (e.g., the target node(s) that is to be executed at) and a service runner instance association. Additionally, once the service runner instance has completed execution of an automation task, the service runner can use the API to update the status of the automation task in the task queue, indicating that it has been completed.

Furthermore, based on target node instance associations 602, the service runner instances 606A-606B may provide redundancy and scalability by enabling automation tasks to be distributed between service runner instances if one service runner instance is unable to execute an automation task, such as because it is already executing other automation tasks, reaches its workload threshold, or becomes temporarily unavailable. Via this redundancy, automation tasks can be consistently executed even if individual service runner instances are subjected to high demand or encounter performance issues. By utilizing multiple service runner instances across utility nodes, the system 600 maintains a high degree of flexibility, scalability, and reliability in managing and executing automation tasks within a managed environment.

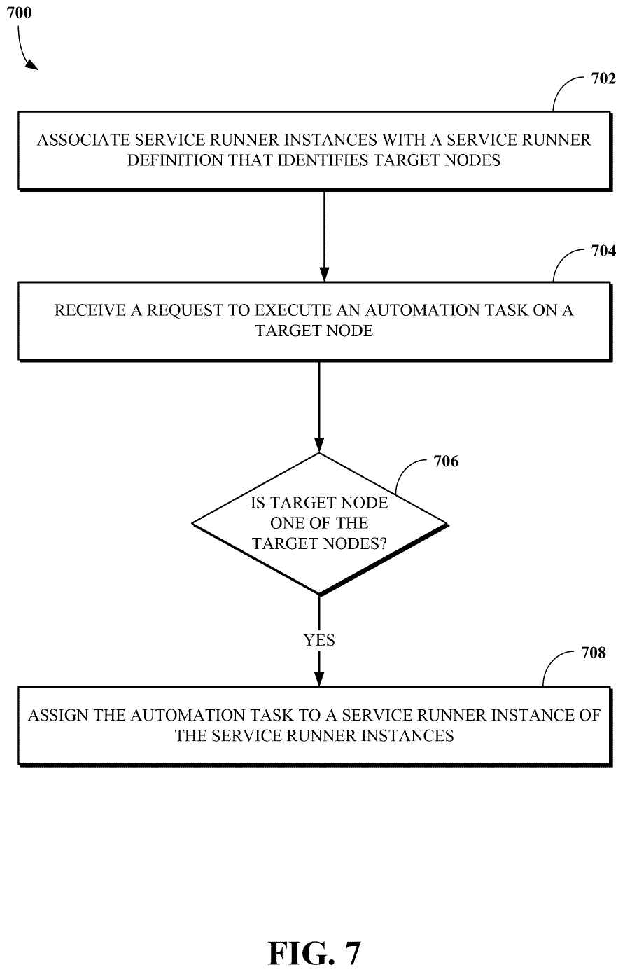

FIG. 7 is a flowchart of a technique 700 for assigning automation tasks to a service runner instance within an infrastructure. The technique 700 can be stored in a memory (such as the memory 304, the processor-readable stationary storage device 334, the processor-readable removable storage device 336 of FIG. 3, or any combination thereof) as instructions that can be executed by a processor (such as the processor 302 of FIG. 3) of a computer (such as the application server computer 112 of FIG. 1). In some implementations, some or all operations of the technique 700 may be performed on a client computer, such as by the client computer 101-104. In some other implementations, some or all operations of the technique 700 may be performed at the enclosure 120 or the enclosure 122, such as by the operations management server computer 116 at the data center 118. The technique 700 may be implemented by a system, such as the system 500 or the system 600 of FIG. 5 and FIG. 6, respectively.

At 702, service runner instances are associated with a service runner definition that identifies target nodes on which the service runner instances are configured to execute automation tasks on the target nodes. The two or more service runner instances may be or be similar to the service runner instances 606A-606B of FIG. 6. The service runner definition may be or be similar to the service runner definitions 508A-508B of FIG. 5. The target nodes may be or be similar to the target nodes 514A-514D of FIG. 5. In other words, one or more service runner instances are defined within the service runner definition that specify the target nodes on which the service runner instances can execute automation tasks.

A service runner instance can be associated with a service runner definition automatically and/or manually. Automated associations of service runner instances with service runner definitions may be performed using APIs. The APIs may be invoked using automated tasks defined with the system or from entities external to the system (i.e., third parties). The system may be or be similar to the system 600 of FIG. 6. Manual association of service runner instances to service runner definitions can be achieved through a graphical user interface (GUI) within the system. Alternatively, a file-based approach, using formats such as, but not limited to yet another markup language (YAML) or JSON, provides a declarative way to manually define these associations. Hybrid methods combine automated and manual methods. An initial manual association can be followed by automated adjustments based on real-time conditions or events. Policy-driven automation can also trigger association changes based on criteria such as instance health, workload, or resource usage. For example, a policy may require that a service runner instance with a health status of “Unhealthy” (or some to other similar status) to be disassociated from the associated service runner definition.

At 704, a request to execute an automation task on a target node is received. The automation task may be or be similar to the automation tasks 506A-506D of FIG. 5. The request may be received by an action execution tool, such as the action execution tool 420 of FIG. 4. Upon receiving the request, the technique 700 analyzes the information associated with the automation task to determine the appropriate handling strategy. This analysis includes but is not limited to identifying the target node, checking the health status of available service runner instances, and evaluating a current workload of a utility node on which the available service runner instances are hosted. In an example, the request to execute the automation task on the target node may be received from a privileged person via a user interface. In an example, the request to execute the automation task on the target node may be received from a workflow executing at or executed by an EMB of the system.

At 706, the technique 700 evaluates whether the target node for the automation task is one of the target nodes associated with the service runner definition. The evaluation is performed by the action execution tool. The action execution tool utilizes service runner instance associations, such as the service runner instance associations 602 of FIG. 6 and target node associations, such as the target node associations 510A-510B of FIG. 5 during the evaluation. The action execution tool determines the service runner definition that is associated with the target node. For example, the service runner definition 508A is associated with target node 514A of FIG. 5. As such, if the target node specified by the automation task is target node 514A, then the action execution tool can determine that the service runner definition 508A is an appropriate service runner definition for the automation task. In an example, the technique 700 may evaluate whether the target node for the automation task is one of the target nodes associated with the service runner definition in response to receiving a request from a service runner instance associated with the service runner definition for an automation task. Said another way, the service runner instance may poll the action execution tool for whether there are any automation tasks for the service runner instance to execute.

At 708, the automation task is assigned to the service runner instance of the service runner instances. That is, the system assigns the automation task to the service runner instance from among the available service runner instances associated with the target node, such as in response to the service runner instance polling for automation tasks.

The automation task is assigned, by the action execution tool, to the designated service runner instance using a task queue, such as the task queue 416 of FIG. 4. For example, if the action execution tool determines that the service runner definition 508A is the appropriate service runner definition for the automation task, based on the target node associations 510A, then the action execution tool is limited to the service runner instances associated with service runner definition 508A based on the service runner instance associations 602. As such, the action execution tool can determine which service runner instances of the service runner instances 606A-606B to assign the automation task to, based on the factors described with respect to operation 704. The automation task is then added to the task queue for execution by the identified service runner instance. In some implementations, the automation task may be added to the task queue based on a unique ID of the identified service runner instance, as such the task queue can be or include a data structure that maps unique IDs of service runner instances to automation tasks. In another example, and as already mentioned, the assignment of the automation task to the service runner instance can be dynamically made in response to polling requests received from service runner instances.

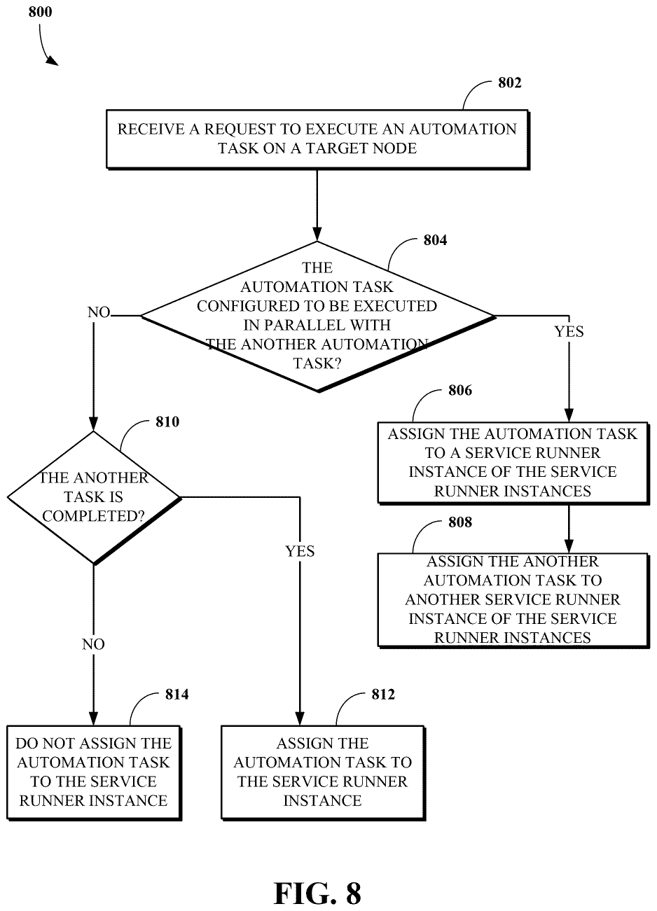

FIG. 8 is a flowchart of a technique 800 for assigning parallel and sequentially executed automation tasks to a service runner instance within an infrastructure. The technique 800 can be stored in a memory (such as the memory 304, the processor-readable stationary storage device 334, the processor-readable removable storage device 336 of FIG. 3, or any combination thereof) as instructions that can be executed by a processor (such as the processor 302 of FIG. 3) of a computer (such as the application server computer 112 of FIG. 1). In some implementations, some or all operations of the technique 800 may be performed on a client computer, such as by the client computer 101-104. In some other implementations, some or all operations of the technique 800 may be performed at the enclosure 120 or the enclosure 122, such as by the operations management server computer 116 at the data center 118. The technique 800 may be implemented by a system, such as the system 500 or the system 600 of FIG. 5 and FIG. 6, respectively.

At 802, a request to execute an automation task on a target node is received. The automation task may be or be similar to the automation tasks 506A-506D of FIG. 5. The request may be received by the action execution tool 420 of FIG. 4. Upon receiving the request, the technique 800 assesses the information associated with the automation task to determine an appropriate handling strategy. The assessment performed by the technique 800 can be or be similar to the assessment described in relation to operation 704 of the technique 700 of FIG. 7.

At operation 804, the technique 800 evaluates whether the automation task is configured for parallel execution with another automation task at the target node. Parallel execution is typically possible when automation tasks are independent of one another, meaning that one is not dependent upon the completion of the other or does not require execution in a specific order. This allows the action execution tool to assign the automation tasks (i.e., the automation task, and the another automation task) to multiple service runner instances operating across the infrastructure. The automation task and the another automation task may be configured to execute in parallel in a workflow.

In some implementation, the technique 800 can determine if two or more automation tasks can be executed in parallel at the target node based on, but not limited to, whether the automation tasks include one or more dependencies to other automation tasks, a quantity of target nodes to be operated on by the automation tasks, a quantity of service runner instances available to execute the automation tasks, a health status of the available service runner instances, other types of technical and functional characteristics of the automation tasks, or a combination thereof. For example, when several automation tasks, each performing a different diagnostic check, need to be performed on the target node, each diagnostic check can be executed in parallel by a different service runner instance. As such, the action execution tool can determine that the automation tasks can be executed in parallel.

In some implementations, the technique 800 can only determine that automation tasks can be executed in parallel based on a configuration of the automation tasks that mark the automation task for parallel execution. For example, a configuration of the automation tasks may include a flag or setting that explicitly indicates whether the automation tasks are to be executed in parallel.

If the automation tasks are configured for parallel execution at the target node, the technique 800 continues to 806; otherwise, the technique 800 continues to 810. In FIG. 8, it is assumed that if two automation tasks are not configured to be executed in parallel, then they must be executed sequentially. If two automation tasks are to be executed in sequence, then a succeeding automation task cannot be started until a preceding automation task is completed.

At 806, the automation task is assigned to a service runner instance of the service runner instances. The service runner instance may be or be similar to the service runner instances 606A-606B of FIG. 6. The assignment process may be or be similar to the assignment process as described by operation 708 of technique 700 of FIG. 7. At 808, the another automation task is assigned to another service runner instance of the service runner instances. In other words, the second automation task (i.e., the another automation task) configured for parallel execution is assigned to a different service runner instance, that is configured to execute commands on the target node, than the first automation task. For example, if the automation task and the another automation task are to be executed at the same target node (e.g., target node 514A) and are configured for parallel execution, the technique 800 can determine that both automation task can be executed by different service runner instances associated with service runner definition 508A. To illustrate, the technique 800 can assign the automation task to the service runner instance 606A and the another automation task to the service runner instance 606B.

As such, in response to receiving a request for automation tasks from the service runner instance 606A, the technique 800 assigns the automation task to the service runner instance 606A; and in response to receiving a request for automation tasks from the service runner instance 606B, while the automation task is not completed, the another automation tasks is assigned to the service runner instance 606B for execution.

At 810, the technique 800 determines whether the another automation task, which is assumed in FIG. 8 to be configured to complete before the automation task is started, is in fact completed. If the another automation task is completed, then the technique 800 proceeds to 812 to assign the automation task to the service runner instance. Otherwise, the technique 800 proceeds to 814 where the automation task is not assigned to the service runner instance. The technique 800 determines whether any other automation tasks associated with the service runner definition can be assigned to the service runner instance and, if so, assigns such automation task to the service runner instance.

In some implementations, other service runner instances may be associated with another service runner definition that identifies other target nodes on which each service runner instance of the other service runners is configured to execute automation tasks on the other target nodes. In other words, a second service runner definition is defined with the system and a second set of service runner instances are associated with the second service runner definition. The second service runner definition identified a second set of target nodes on which the second set of service runner instances are configured to execute automation tasks.

To illustrate, in a scenario where an organization is managing both on-premises and cloud-based infrastructures, a first service runner definition can be defined to identify the target nodes within the cloud-based infrastructure and the second service runner definition (i.e., the another service runner definition) can be defined to identify the target nodes within the on-premises infrastructure. As such, service runner instances associated with the first service runner definition can execute automation tasks within the cloud-based infrastructure, while the second set of service runner instances can execute task within the on-premises infrastructure. The association between the other service runner instances and another service runner definition may be similar to service runner instances associated with the service runner definition as described above in reference to operation 702 of FIG. 7.

In some implementations, a request to execute another automation task on another target node may be received. The another automation task may be or be similar to the automation tasks 506A-506D of FIG. 5. The request may be received by an action execution tool, such as the action execution tool 420 of FIG. 4. Upon receiving the request the information associated with the automation task is analyzed to determine an appropriate handling strategy. The analysis may be or be similar to the analysis performed in reference to operation 704 of technique 700 of FIG. 7.

In some implementations, whether the another target node for the automation task is one of the other target nodes associated with the another service runner definition is evaluated. The evaluation is be performed by the action execution tool. The evaluation may be or be similar to the evaluation performed at operation 706 of technique 700 of FIG. 7 above.

In some implementations, the another automation task is assigned to another service runner instance of the other service runner instances. That is, the another automation task is assigned to a specific service runner instance from among the available service runner instances associated with the another target node. The automation task is assigned by an action execution tool such as the action execution tool 420 of FIG. 4, to the another service runner instance using a task queue, such as the task queue 416 of FIG. 4.

For example, consider a scenario where an IT infrastructure includes a first set of servers running a first operating system (e.g., Linux) and a second set of server running a second operations system (e.g., Microsoft Windows). Two service runner definitions may be defined, the first service runner definition is associated with target nodes running the first operating system and the second service runner definition is associated with the other target nodes running the second operating system. The first service runner definition is associated the other service runner instances configured to execute automation tasks on the target nodes running the first operating system and the second service runner definition is associated with the service runner instances configured to execute automation tasks on the other target nodes running the second operating system. When an automation task targeting a first operating system server is received, the action execution tool assigns the automation task to the service runner instance of the service runner instances associated with the first service runner definition. Conversely, when another automation task targeting a Windows server is received, the action execution tool assigns the another automation task to another service runner definition of the other service runner instances associated with the second service runner definition.

In some implementations, a request to execute a quantity (i.e., a number) of automation tasks, above a threshold number, on a target node may be received. The quantity of automation tasks may be or be similar to the automation tasks 506A-506D of FIG. 5. The request may be received by the action execution tool 420 of FIG. 4. The threshold number may be based on a variety of factors, including, but not limited to, system capacity, target node capabilities, expected workload levels within the distributed infrastructure, or the like. The threshold number is a reference point, indicating the point at which task distribution among multiple service runner instances becomes beneficial to maintain system performance. When the number of automation tasks exceeds the threshold number, assigning all tasks through a single service runner instance could lead to bottlenecks, increased latency, and potentially diminished performance.

In some implementations, a portion of the quantity of automation tasks may be assigned to a service runner instance and another portion of the quantity of automation tasks are assigned to another service runner instance of the service runner instances. That is, upon receiving a request to execute a number of automation tasks above the threshold number, the technique 1000 allocates portions of the automation tasks amongst the service runner instances. For example, in a scenario involving data backup operations across multiple server nodes, via multiple automation tasks, if the number of backup tasks (i.e., automation tasks) surpasses the threshold number, a first number (e.g., half) of the backup tasks may be assigned to one service runner instance and the remaining number (e.g., the other half) may be assigned to another service runner instance. The first number of backup tasks may correspond to the first half of the target nodes targeted by the data backup operations. For example, given that the data backup operations target 1000 nodes, the first number of back up tasks may correspond to a first 500 target nodes (e.g., target nodes 1-500) and the remaining number of the backup tasks may correspond to a second 500 target nodes (e.g., target nodes 501-1000).

While the number of service runner instances in which the automation tasks are distributed between is two in the previous example, the disclosure is not so limited. The automation tasks can be distributed between any number of service runner instances associated with the service runner definition. Additionally, the portions assigned to each service runner, while equal in the prior example, do not need to be equal. The automation tasks can be apportioned between the service runner instances using many suitable method of distribution such as but not limited to round-robin assignments, weighted distributions based on instance capabilities, or dynamic allocation based on real-time service runner instance health status and workload.

In some implementations, a request to execute two or more automation tasks configured to be executed on a quantity of target nodes may be received. The two or more automation tasks may be or be similar to the automation tasks 506A-506D of FIG. 5. The quantity of target nodes may be or be similar to the target nodes 514A-514D of FIG. 5. The request may be received by the action execution tool 420 of FIG. 4. Upon receiving the request, the request is analyzed to determine how to apportion the automation tasks between the service runner instances associated with the service runner definitions that identify each target node of the quantity of target nodes. The analysis includes, but is not limited to, determining a total number of target nodes on which the automation tasks are to be executed, and a total number of service runner instances associated with the service runner definition. A ratio of the quantity (i.e., total number) of target nodes to the total number of service runner instances may be calculated.

For example, a financial institution may need to perform daily security scans on all its servers across a data center. As such, the financial institution has defined a service runner definition and associated multiple service runner instances with the service runner definition. The service runner definition is associated with the target nodes in the data center. Additionally, one or more automation tasks can be defined to execute the daily security scans across all the target nodes within the data centers. As such, the quantity of target nodes on which the daily security scans are to be run may be a large quantity of target nodes.

In some implementations, a portion of the two or more automation tasks two may be assigned to a service runner instance and another portion of the two or more automation tasks are assigned to another service runner instance of service runner instances wherein the portion and the another portion are based on the ratio of the quantity of target nodes to the total number of service runner instances. In other words, portions of the automation tasks are assigned to the available service runner instances. This size of each portion (i.e., the portion, the another portion) are calculated according to the ratio of the quantity of target nodes to the total number of service runner instances. For example, if there are four target nodes and two service runner instances, the system would assign an equal portion of the tasks to each service runner instance, ideally two nodes per instance. However, in cases where the ratio is uneven or where certain tasks require specific resource considerations, the system can adjust the distribution to match the needs.

In some implementations, the targets may be identified by multiple service runner definitions. For example, consider the same financial institution from before, only now the servers are located across multiple data centers. Instead of a single service runner definition, the financial institution can define multiple service runner definitions. Each service runner definition can have multiple service runner instances associated with it. Additionally, each service runner definition can identify multiple targets. Depending on the size and configuration of each data center, there may be multiple service runner definitions for each data center. Using the proportional distribution method described above, the system can distribute the automation tasks according to the ratio of target nodes identified by each service runner definition to the number of available service runner instances associated with each service runner definition.

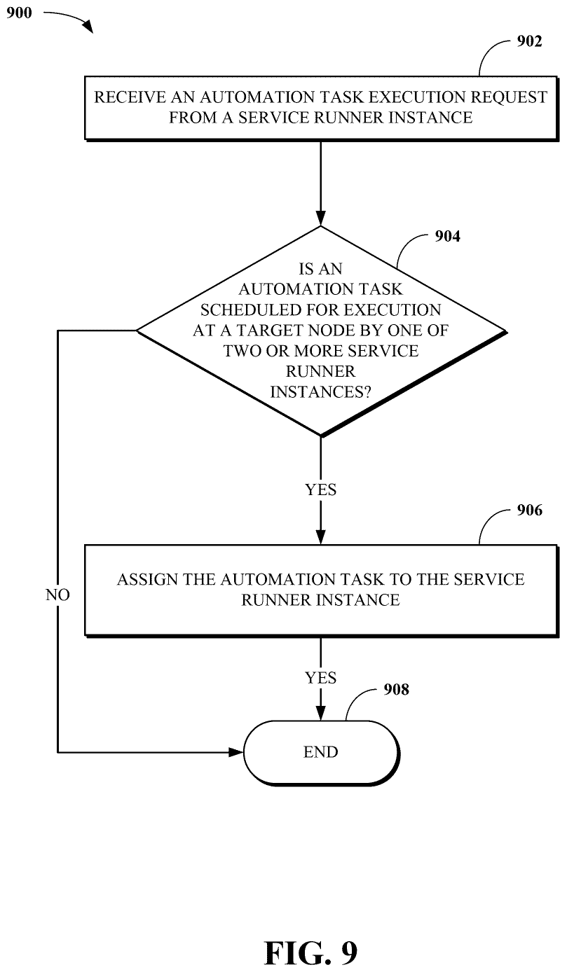

FIG. 9 is a flowchart of a technique 900 for receiving an automation task execution request from a service runner instance. The technique 900 can be stored in a memory (such as the memory 304, the processor-readable stationary storage device 334, the processor-readable removable storage device 336 of FIG. 3, or any combination thereof) as instructions that can be executed by a processor (such as the processor 302 of FIG. 3) of a computer (such as the application server computer 112 of FIG. 1). In some implementations, some or all operations of the technique 900 may be performed on a client computer, such as by the client computer 101-104. In some other implementations, some or all operations of the technique 900 may be performed at the enclosure 120 or the enclosure 122, such as by the operations management server computer 116 at the data center 118. The technique 900 may be implemented by a system, such as the system 500 or the system 600 of FIG. 5 and FIG. 6, respectively.

At 902, an automation execution task request is received from a service runner instance. The request may be received by the action execution tool 420 of FIG. 4. The service runner instance may be or be similar to the service runner instances 606A-606B of FIG. 6. That is, a service runner instance polls the action execution tool for available automation tasks. The request may be a query to an API to see if any automation tasks are available and designated for the service runner instance. The service runner may initiate the request based on a predefined interval, based on a defined trigger, or in some other suitable manner. For example, the service runner instance can be configured to send an automation execution task request to the action execution tool at predefined intervals, such as every 10 seconds. Alternatively, the service runner instance can be configured to send an automation execution task request to the action execution tool upon completion of an automation task. In another example, the service runner instance can be configured to use a combination of a predefined interval or trigger-based requests.

At 904, the technique 900 determines if an automation task is scheduled for execution at a target node by one of two or more service runner instances. The automation task may be or be similar to the automation tasks 506A-506D of FIG. 5. That is the action execution tool can check the task queue, such as the task queue 416 of FIG. 4, for automation tasks that are scheduled for execution at the target node, in which, the target node is associated with the service runner instance based an associated service runner definition. The service runner definition may be or be similar to the service runner definitions 508A-508B of FIG. 5. The target node may be or be similar to the target nodes 512D-514D of FIG. 5. The service runner instance is associated to the service runner definition via service runner instance associations, such as the service runner instance associations 602 of FIG. 6.

For example, if service runner instance, such as the service runner instance 606A of FIG. 6 requests an automation task from the action execution tool, the action execution tool can check the task queue for any automation tasks that target (e.g., are to be executed at) the target node 514A. If an automation task is scheduled to be executed at target node 514A, the technique 900 determines that there is an automation task to be executed by the service runner instance. If the technique 900 determines that there is an automation task to be executed by the service runner, the technique 900 proceeds to operation 906 to assign the automation task to the service runner instance; otherwise the technique 900 ends at 908 and does not assign an automation task to the service runner instance.

As described with respect to FIG. 8, the assignment of the automation task to the service runner instance can be based on a sequential or parallel configuration of the automation task with respect to at least one other automation task and the status of that other automation task, and/or the overall quantity of automation tasks to be handled.

In an example, determining that the automation task is scheduled for execution at the target node by the one of two or more service runner instances may include identifying a service runner definition associated with the service runner instance, wherein the service runner definition associates the two or more service runner instances with a set of target nodes that includes the target node.

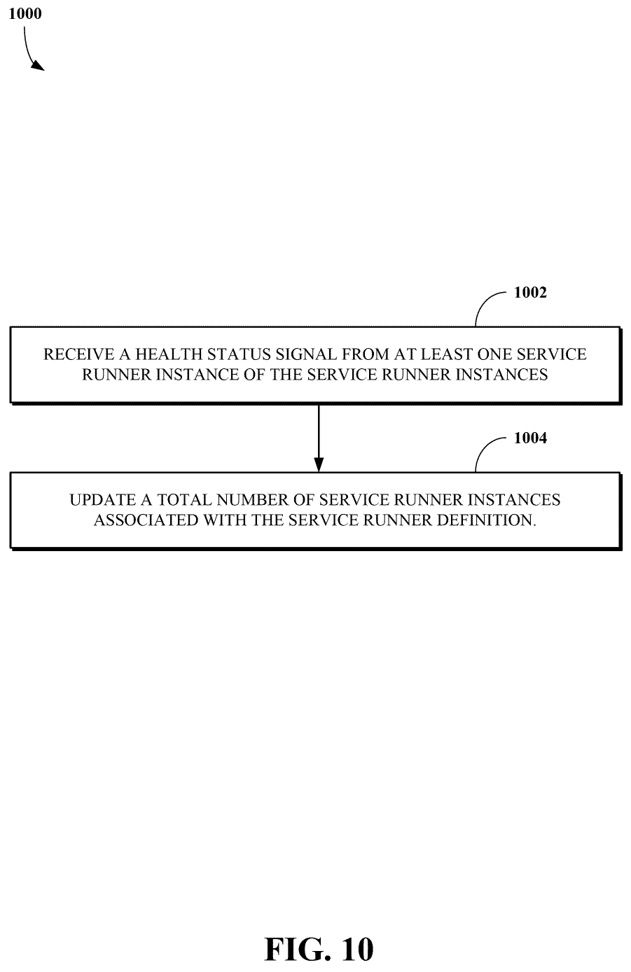

In some implementations, the service runner definition includes a flag indicating that service runner instances associated with the service runner definition are dynamically allocated. The service runner definition may be or be similar to the service runner definitions 508A-508B of FIG. 5. The flag may indicate that the service runner definition is ephemeral as described below in more detail with respect to FIG. 10. Additionally, a total number of service runner instances associated with the service runner definition may be updated based on a number of health status signals received. The health status signals may be received from a service runner instance, such as one of the service runner instances 606A-606B of FIG. 6, as described in more detail below With respect to FIG. 10.

FIG. 10 is a flowchart of a technique 1000 for updating a health status of a service runner instance. The technique 1000 can be stored in a memory (such as the memory 304, the processor-readable stationary storage device 334, the processor-readable removable storage device 336 of FIG. 3, or any combination thereof) as instructions that can be executed by a processor (such as the processor 302 of FIG. 3) of a computer (such as the application server computer 112 of FIG. 1). In some implementations, some or all operations of the technique 1000 may be performed on a client computer, such as by the client computer 101-104. In some other implementations, some or all operations of the technique 1000 may be performed at the enclosure 120 or the enclosure 122, such as by the operations management server computer 116 at the data center 118. The technique 1000 may be implemented by a system, such as the system 500 or the system 600 of FIG. 5 and FIG. 6, respectively.

At 1002, a health status signal from at least one service runner instance of the service runner instances is received. That is, the technique 1000 receives a health status signal from at least one service runner instance among the service runner instances. The health status signal includes a unique ID of a service runner instance such that the health status signal can be associated with a specific service runner instance of the service runner instances. The health status signal provides information regarding the operational status, availability, and performance of the specific service runner instance from which it originates. Health status signals can include various metrics, such as CPU usage, memory utilization, network connectivity, and error logs, which collectively offer a snapshot of the instance's current operational health. Additionally, the health status signal may include indicators of specific issues, such as high resource consumption, latency in automation task processing, or instances of failures or crashes.

At 1004, a total number of service runner instances associated with the service runner definition is updated. In other words, based on the health status signal received from one or more service runner instances, the technique 1000 updates the total number of available service runner instances associated with the service runner definition. Additionally, the technique updates the health status of respective service runner instance based on the health status signal. The health status is an internal record or data structure that reflects the real-time condition and availability of the service runner instance for executing assigned automation tasks. When the health status signal indicates normal operating conditions, the technique 1000 may confirm or mark the instance as “healthy” or “available.” In contrast, if the health status signal reveals performance issues or failures, the health status is adjusted to reflect a degraded state, such as “underperforming” or “unavailable.” This updated health status enables the technique 1000 to make informed decisions when distributing automation tasks across the infrastructure. For example, in some implementations, if a particular service runner instance is marked as “unavailable” due to a failure detected in the health signal, the technique 1000 can reassign pending or future automation tasks to other healthy service runner instances, thereby avoiding delays and maintaining continuous workflow execution.

A service runner definition may be designated (i.e., flagged) as “ephemeral,” which indicates that the number of active service runner instances associated with this definition is not statically predefined or directly controlled by the system itself but rather is dynamically allocated and controlled by an external source. The designation as ephemeral implies that the total number of service runner instances available at any given time is subject to fluctuations based on real-time conditions or demand as determined by an external management layer, such as but not limited to an external orchestrator, resource manager, or a cloud-based auto-scaling system. Consequently, the technique 1000 cannot inherently know the exact number of active service runner instances associated with an ephemeral service runner definition at a given moment.

To track the availability of service runner instances under an ephemeral service runner definition, the technique 1000 relies on the health status of each service runner instance associated to the service runner definition. Health status updates, as described previously, provide real-time indicators of the current operational state of each service runner instance, such as whether it is active, available, underperforming, or unavailable. Through this mechanism, the technique 1000 can monitor the health signals from the service runner instances to determine which instances are currently available to execute automation tasks. When a service runner instance becomes inactive or unresponsive, its health status reflects this change, enabling the technique 1000 to adjust the automation task assignment accordingly. Furthermore, the technique 1000 can automatically remove (e.g., expire, disassociate) a service runner instance from a service runner definition when no health status signal is received from the service runner instance after a predetermined interval. Conversely, when new service runner instances are dynamically brought online by the external source, the health status of the new service runner instance will indicate availability, allowing the technique 1000 to include these new service runner instances in the automation task distribution pool.

For simplicity of explanation, the techniques 700, 800, 900, and 1000 of FIGS. 7, 8, 9, and 10 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, Common business-oriented language (COBOL), Java™, PHP, Perl, JavaScript, Ruby, Visual Basic Script (VBScript), Microsoft . NET™ languages such as C #, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving an automation task execution request from a service runner instance;
determining that an automation task is scheduled for execution at a target node by one of two or more service runner instances, wherein the two or more service runner instances include the service runner instance; and
assigning the automation task to the service runner instance based on determining that the automation task is scheduled for execution at the target node by the one of two or more service runner instances.

2. The method of claim 1, wherein determining that the automation task is scheduled for execution at the target node by the one of two or more service runner instances comprises:
identifying a service runner definition associated with the service runner instance, wherein the service runner definition associates the two or more service runner instances with a set of target nodes that includes the target node.

3. The method of claim 2, wherein the service runner definition includes a flag indicating that service runner instances associated with the service runner definition are dynamically allocated, further comprising:
updating a total number of service runner instances associated with the service runner definition based on a number of health status signals received.

4. The method of claim 1, further comprising:
determining that the automation task is configured for parallel execution with another automation task; and
assigning the another automation task to another service runner instance based on a determination that the automation task is configured for parallel execution with the another automation task, wherein the another service runner instance is one of the two or more service runner instances.

5. The method of claim 1, further comprising:
determining that the automation task is configured for sequential execution with another automation task; and
assigning the another automation task to the service runner instance based on a determination that the automation task is configured for sequential execution with the another automation task.

6. A method, comprising:
associating service runner instances with a service runner definition, wherein the service runner definition identifies target nodes, wherein each service runner instance of the service runner instances is configured to execute automation tasks on the target nodes;
receiving a request to execute an automation task on a target node;
determining that the target node is one of the target nodes; and
assigning, in response to determining that the target node is one of the target nodes, the automation task to a service runner instance of the service runner instances.

7. The method of claim 6, comprising:
receiving a request to execute another automation task in sequence with the automation task on the target node; and
assigning the another automation task to the service runner instance.

8. The method of claim 6, wherein the service runner instances comprise another service runner instance, further comprising:
receiving a request to execute another automation task in parallel with the automation task on the target node; and
assigning the another automation task to the another service runner instance.

9. The method of claim 6, comprising:
associating other service runner instances with another service runner definition, wherein the another service runner definition identifies other target nodes, wherein each service runner instance of the other service runner instances is configured to execute automation tasks on the other target nodes;
receiving a request to execute another automation task on another target node;
determining that another target node is one of the other target nodes; and
assigning, in response to determining that the another target node is one of the other target nodes, the another automation task to another service runner instance of the other service runner instances.

10. The method of claim 6, comprising:
receiving a request to execute a quantity of automation tasks above a threshold number on the target node; and
assigning a portion of the quantity of automation tasks to the service runner instance and another portion of the quantity of automation tasks to another service runner instance of the service runner instances.

11. The method of claim 10, wherein the portion and the another portion are equal.

12. The method of claim 6, comprising:
receiving another request to execute two or more automation tasks configured to be executed on a quantity of target nodes, wherein the automation task is included in the two or more automation tasks; and
assigning a portion of the two or more automation tasks to the service runner instance and another portion of the two or more automation tasks to another service runner instance of the service runner instances wherein the portion and the another portion are based on a ratio of the quantity of target nodes to a total number of service runner instances.

13. The method of claim 6, wherein the service runner definition includes a flag indicating that service runner instances associated with the service runner definition are dynamically allocated, further comprising:
receiving a health signal from at least one service runner instance of service runner instances; and
updating a total number of service runner instances associated with the service runner definition based on a number of health status signals received.

14. A system, comprising:
a memory subsystem configured to store instructions; and
processing circuitry configured to execute instructions to:
associate service runner instances with a service runner definition, wherein the service runner definition identifies target nodes, wherein each service runner instance of the service runner instances is configured to execute automation tasks on the target nodes;
receive a request to execute an automation task on a target node;
determine that the target node is one of the target nodes; and
assign, in response to determining that the target node is one of the target nodes, the automation task to a service runner instance of the service runner instances.

15. The system of claim 14, wherein the processing circuitry is further configured to execute instructions to:
receive a request to execute another automation task in sequence with the automation task on the target node; and
assign the another automation task to the service runner instance.

16. The system of claim 14, wherein the service runner instances comprise another service runner instance and the processing circuitry is further configured to execute instructions to:
receive a request to execute another automation task in parallel with the automation task on the target node; and
assign the another automation task to the another service runner instance.

17. The system of claim 14, wherein the processing circuitry is further configured to execute instructions to:
associate other service runner instances with another service runner definition, wherein the another service runner definition identifies other target nodes, wherein each service runner instance of the other service runner instances is configured to execute automation tasks on the other target nodes;
receive a request to execute another automation task on another target node;
determine that another target node is one of the other target nodes; and
assigning, in response to determining that the another target node is one of the other target nodes, the another automation task to another service runner instance of the other service runner instances.

18. The system of claim 14, wherein the processing circuitry is further configured to execute instructions to:
receive a request to execute a quantity of automation tasks above a threshold number on the target node; and
assign a portion of the quantity of automation tasks to the service runner instance and another portion of the quantity of automation tasks to another service runner instance of the service runner instances.

19. The system of claim 14, wherein the processing circuitry is further configured to execute instructions to:
receive another request to execute two or more automation tasks configured to be executed on a quantity of target nodes, wherein the automation task is included in the two or more automation tasks; and
assign a portion of the two or more automation tasks to the service runner instance and another portion of the two or more automation tasks to another service runner instance of the service runner instances wherein the portion and the another portion are based on a ratio of the quantity of target nodes to a total number of service runner instances.

20. The system of claim 14, wherein the service runner definition includes a flag indicating that service runner instances associated with the service runner definition are dynamically allocated and the processing circuitry is further configured to execute instructions to:
update a total number of service runner instances associated with the service runner definition based on a number of health status signals received.
